(19) United States
(12) Patent Application Publication
(10) Pub. No.: US 2026/0099814 A1
(43) Pub. Date: Apr. 9, 2026

(54) SYSTEMS AND METHODS FOR AUDITING RETAIL INVENTORY

(71) Applicant: Walmart Apollo, LLC, Bentonville, AR (US)

(72) Inventors: Morgan J. Sannes, Conshohocken, PA (US); Arpan Bajoria, Cupertino, CA (US); Thanmaya B. Raghuram, North Caldwell, NJ (US); Ramanujam Ramaswamy Srinivasa, Bengaluru (IN); Prerana Chinnappa, Maple Valley, WA (US); Manish Kumar, Bangalore (IN); Sindiri S. Kumar, Bengaluru (IN); Naman Kaushik, Hapur (IN); Kushagra Saini, Ajmer (IN); Rohit Sharma, Mathura (IN); Pranav Aggarwal, Navi Mumbai (IN)

(21) Appl. No.: 19/349,354

(22) Filed: Oct. 3, 2025

Related U.S. Application Data
(60) Provisional application No. 63/703,052, filed on Oct. 3, 2024.

(51) Int. Cl. G06Q 10/087

(52) U.S. Cl. CPC G06Q 10/08772

(57) ABSTRACT

In some embodiments, apparatuses and methods are provided herein useful to audit retail inventory. In some embodiments, a system includes an application executing on an electronic user device that displays an image showing a plurality of cases positioned at a storage location of a storage area. The system augments the image with a first indicator case overlay positioned over a portion of each case that is not associated with the storage location in an inventory database, receive a user selection of at least one case that has been augmented with the first indicator case overlay, output signaling to cause the inventory database to associate the at least one case with the storage location, and augment the image to replace the first indicator case overlay with a second indicator case overlay positioned over the portion of the at least one case having been selected.

### CROSS-REFERENCE TO RELATED APPLICATIONS

This application claims the benefit of U.S. Provisional Application 63/703,052 filed Oct. 3, 2024, which is incorporated by reference in its entirety.

### TECHNICAL FIELD

This invention relates generally to auditing retail inventory.

### BACKGROUND

Conventional inventory audit systems typically require store associates to scan barcodes or manually verify bin assignments, which can be time-consuming and susceptible to human error. Existing systems also do not provide intuitive visual feedback to help store associates quickly identify and correct discrepancies between the physical location of cases and their recorded assignments in an inventory database.

### BRIEF DESCRIPTION OF THE DRAWINGS

Disclosed herein are embodiments of systems, apparatuses, and methods pertaining to auditing retail inventory. This description includes drawings, wherein:

FIG. 1 is a block diagram of a retail inventory auditing system in accordance with several embodiments.

FIG. 2 is an illustration of a plurality of cases having machine detectable identifiers and positioned at storage locations of a storage area in accordance with several embodiments.

FIG. 3A is an image of a user interface of an electronic user device displaying an augmented view of cases positioned at a storage location in accordance with several embodiments.

FIG. 3B is an image of a user interface of an electronic user device displaying an augmented view of cases positioned at a storage location in accordance with several embodiments.

FIG. 3C is an image of a user interface of an electronic user device displaying an augmented view of cases positioned at a storage location in accordance with several embodiments.

FIG. 4 is an image of a user interface of an electronic user device displaying an augmented view of a plurality of storage areas in accordance with several embodiments.

FIG. 5A is an illustration of a user holding an electronic user device in front of a storage area and a user interface of the electronic user device displaying an augmented live view of the storage area in accordance with several embodiments.

FIG. 5B is an illustration of a user holding an electronic user device in front of a storage area and a user interface of the electronic user device displaying an augmented static view of a live view of the storage area in accordance with several embodiments.

FIG. 6A is an image of a user interface of an electronic user device displaying an augmented view of cases in accordance with several embodiments.

FIG. 6B is an image of a user interface of an electronic user device displaying an augmented view of cases in accordance with several embodiments.

FIG. 7A is an image of a user interface of an electronic user device displaying an augmented view of cases positioned at a storage location in accordance with several embodiments.

FIG. 7B is an image of a user interface of an electronic user device displaying an augmented view of cases positioned at a storage location in accordance with several embodiments.

FIG. 8 is an illustration of changing the range of cases displayed by a user interface of an electronic user device in accordance with several embodiments.

FIG. 9 is a flow diagram of a method of auditing retail inventory in accordance with several embodiments.

FIG. 10 is a block diagram of a retail inventory auditing system in accordance with several embodiments.

### DETAILED DESCRIPTION

The following description is not to be taken in a limiting sense but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

The present invention addresses various shortcomings associated with conventional inventory systems by providing an augmented reality display that visually identifies cases located at a specific storage location and distinguishes those correctly assigned from those associated with other storage locations. Using visual cues such as, for example, color coding, shape overlays, and the like, the systems, apparatuses, and methods described herein enable store associates to easily recognize which cases belong at their current location and which require reassignment. This approach enhances inventory accuracy, streamlines audit procedures, and reduces the cognitive and operational burden on retail personnel.

Generally speaking, pursuant to various embodiments, systems, apparatuses, and methods are provided herein useful to auditing retail inventory. In some embodiments, a system for auditing retail inventory includes an application configured to be stored in a memory of an electronic user device. The application can be executed by a control circuit of the electronic user device. In some embodiments, when executed, the application may provide a user interface on an electronic device. In some embodiments, the application may display an image of a storage area on a display screen of the electronic device. The image can include a storage location and/or a plurality of cases positioned at the storage location. In some embodiments, the plurality of cases has machine detectable identifiers. Alternatively, or in addition, the application may augment the image with a first indicator case overlay positioned over a portion of each of the plurality of cases that are not associated with the storage location in an inventory database. Alternatively, or in addition, the application may receive a user selection of at least one case that has been augmented with the first indicator case overlay. Alternatively, or in addition, the application may output signaling to cause the inventory database to associate the at least one case with the storage location. Alternatively, or in addition, the application may augment the image to replace the first indicator case overlay with a second indicator case overlay positioned over the portion of the at least one case having been selected. In some embodiments, the second indicator case overlay may indicate to the user that the at least one case is associated with the storage location in the inventory database.

In some embodiments, a method for auditing retail inventory includes displaying, by an application stored in a memory of an electronic user device and when executed by a control circuit of the electronic user device, an image of a storage area on a display screen of the electronic user device. For example, the image includes a storage location and a plurality of cases positioned at the storage location. The plurality of cases may have machine detectable identifiers. The method may include augmenting, by the application, the image with a first indicator case overlay positioned over a portion of each of the plurality of cases that are not associated with the storage location in an inventory database. Alternatively, or in addition, the method may include receiving, by the application, a user selection of at least one case that has been augmented with the first indicator case overlay. Alternatively, or in addition, the method may include outputting, by the application, signaling to cause the inventory database to associate the at least one case with the storage location. Alternatively, or in addition, the method may include augmenting, by the application, the image to replace the first indicator case overlay with a second indicator case overlay positioned over the portion of the at least one case having been selected. The second indicator case overlay can indicate to the user that the at least one case is associated with the storage location in the inventory database.

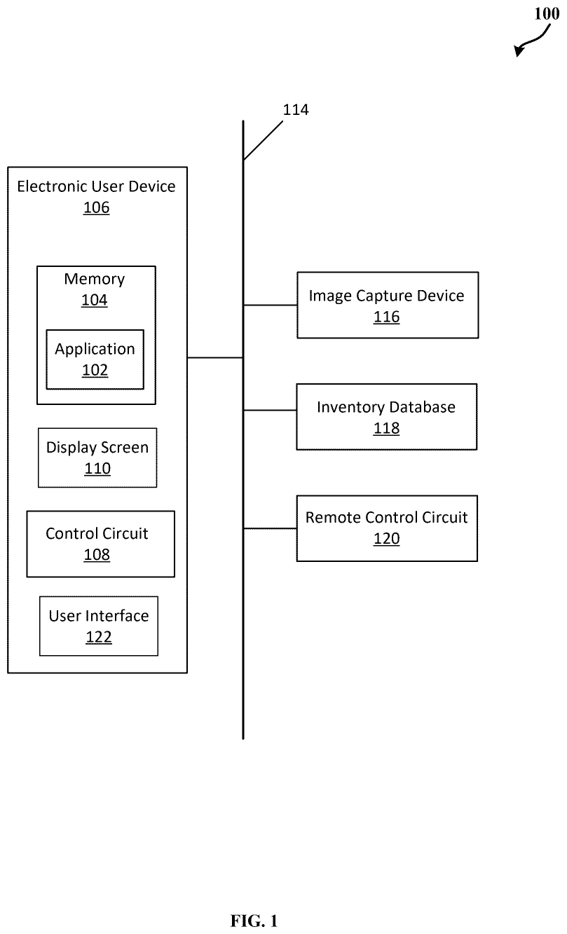

In an illustrative non-limiting example, FIG. 1 illustrates a block diagram of one or more components, elements, and/or features of a system 100 for auditing retail inventory according to some embodiments. The system 100 includes application 102. In some embodiments, the application 102 is stored in a memory 104 (e.g., random access memory (RAM), read only memory (ROM), solid state devices, hard drives, and/or any equivalents thereof) of an electronic user device 106. Alternatively or in addition, the application 102 may be stored in a cloud storage system including one or more various memory storage type devices, such as network attached storage, capable of being accessed via a communication network 114 (e.g., Internet, local area network (LAN), wireless and/or wired network, to name a few) by multiple computers, servers, electronic devices, control circuits, and/or any equivalents thereof. Alternatively, or in addition, the system 100 may include a user interface 122 shown on a display screen 110 of the electronic user device 106. In some embodiments, the user interface 122 may be initiated when the application 102 is executed by a control circuit 108. In some embodiments, the control circuit 108 may include one or more processors associated with the electronic user device 106. In some embodiments, the application 102 may be associated with a retailer and/or downloaded into the electronic user device 106. Application 102 works cooperatively with control circuit 108 to provide the user interface 122 displayed on display screen 110.

In some embodiments, system 100 may include an image capture device 116. In some embodiments, the image capture device is used in stock areas (e.g., stock room or back room of a facility). In some embodiments, the image capture device may be used in areas where customers may be present (e.g., salesfloor of a facility). However, in the areas where customers may be present, the system 100 does not intend to include or capture images of customers in the camera view; and even if a customer is captured, the system 100 does not attempt to recognize them, use facial recognition or attempt to identify individual customers. The image capture device 116 may include an image capture device of the electronic user device 106 (e.g., camera mounted on/part of the electronic user device 106), a fixed image capture device (e.g., one or more cameras mounted inside a stockroom/backroom and/or salesfloor of a facility) and/or a portable image capture device (e.g., camera mounted on/part of an automated machine (e.g., a robot) capable of maneuvering inside the stockroom/backroom and/or salesfloor of the facility and/or programmed to perform actions (e.g., capturing images of the storage areas and the cases associated with the storage areas in the stockroom/backroom and/or salesfloor of the facility)). For example, the storage areas may include pallets, shelves, racks, and/or bins, to name a few. The cases may include boxes having products inside, bundled products kept as a single unit, and/or individual items of products placed on and/or stored in the storage areas. In some embodiments, system 100 may include one or more inventory databases 118. In one example, one or more inventory databases 118 may store information of storage areas where cases are located, location labels associated with the storage areas and/or machine detectable identifiers associated with the cases.

In some embodiments, the storage areas are located in a stockroom/backroom of a facility (e.g., a retail store, a distribution center, and/or a storage facility, to name a few) and the cases are overstock cases that could not fit on a salesfloor. For example, some of the cases containing the products are stored in one storage area while the remaining cases containing the same products are stored in another storage area. In some embodiments, a remote control circuit 120 may update one or more inventory databases 118 with the current storage areas where each case in the inventory is stored.

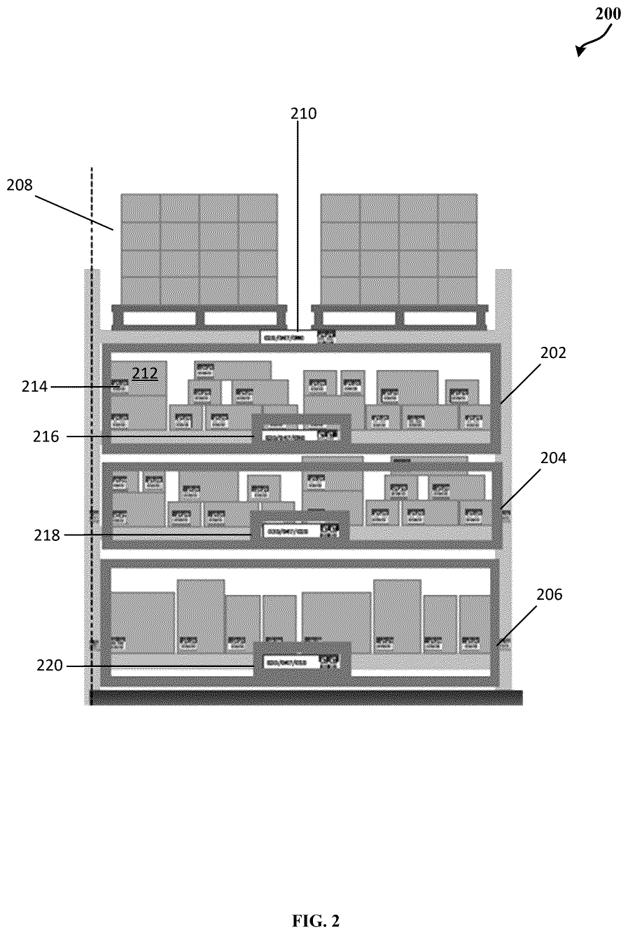

FIG. 2 shows an example diagram of storage areas 200 according to some embodiments. In some embodiments, a storage area may correspond to a shelf of a rack. Each storage area may be associated with a storage location. For example, the storage areas 200 includes a first storage area 202 with a corresponding first storage location label 216, a second storage area 204 with a corresponding second storage location label 218, a third storage area 206 with a corresponding third storage location label 220, and/or a fourth storage area 208 with a corresponding fourth storage location label 210. In some embodiments, the location labels 216, 218, 220 and 210 can each include a machine detectable location identifier. Each storage area can store one or more cases. For example, the first storage area 202 may store multiple cases, such as case 212. In some embodiments, case 212 has a machine detectable identifier 214 affixed on its surface. Similarly, the second, third, and/or fourth storage areas 204, 206, 208 may store one or more cases as shown in FIG. 2. In some embodiments, the machine detectable identifier 214 may include a machine-readable code such as Universal Product Code (UPC), Quick Response (QR) code, and/or any other machine-readable codes capable of being read by a machine-code scanner (e.g., a smartphone, a barcode reader, to name a few).

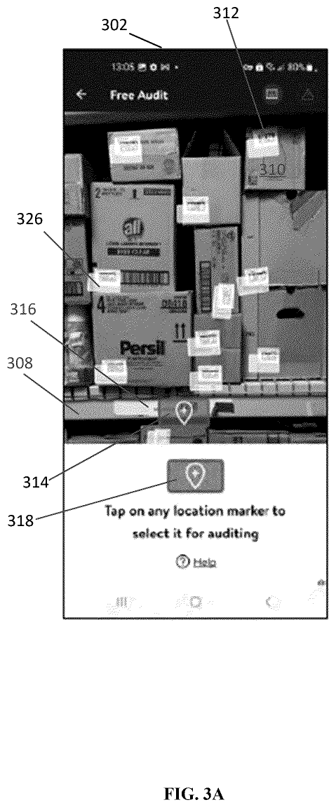

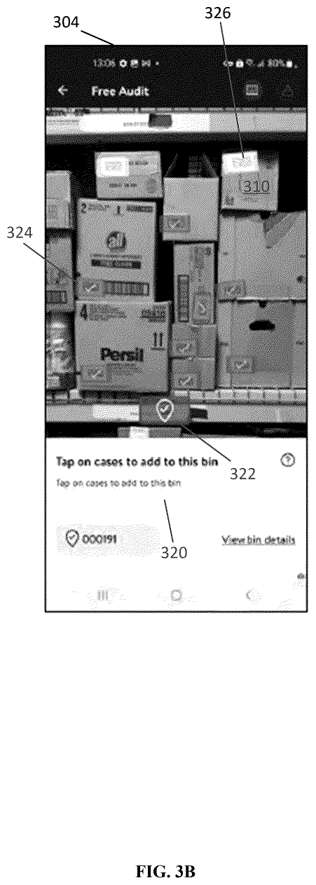

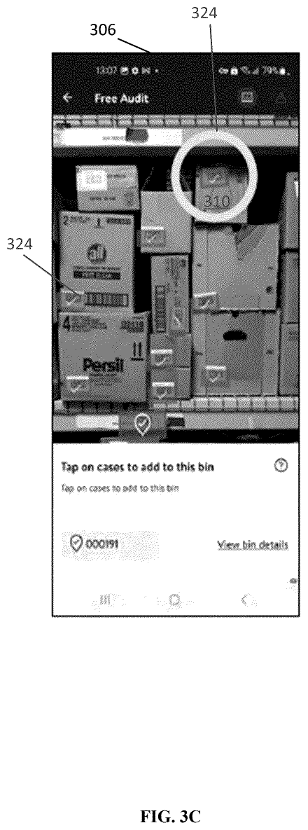

FIGS. 3A-3C shows images of a storage area shown on a display screen during an audit of retail inventory according to some embodiments. In an illustrative non-limiting example of a system for auditing retail inventory, an application 102 stored in memory 104 of an electronic user device 106 may be executed by a control circuit 108 of the electronic user device 106. In some embodiments, when application 102 is executed, a user interface 122 is displayed on the electronic user device 106. For example, application 102 displays the first image 302 of the user interface 122 on a display screen 110 of the electronic user device 106. The first image 302 can include a storage area 308 and/or a storage location associated with a location label 316. In some embodiments, a plurality of cases is positioned at the storage location and/or the storage area 308 and may have machine detectable identifiers. For example, a machine detectable identifier 312 is affixed on case 310 as shown in FIG. 3A. The first image 302 of FIG. 3A can include a location label 316 (or marker or identifier) augmented with a storage location overlay 314. For example, application 102 may overlay a storage location overlay over a location label of a storage area depicted on an image. In some configurations, the location label may indicate identifiable information (e.g., products stored in the storage area 308 and/or the storage location, and assigned location coordinate and/or area in the facility, to name a few) of the storage area.

In some embodiments, the storage location overlay 314 may include one or more combinations of a symbol, a color, and/or a shape. In some embodiments, application 102 may display a first feature 318 prompting a user to select a location label 316 via a selection of a storage location overlay 314 for auditing. In some embodiments, the user may select the storage location overlay 314. In response to the selection of the storage location overlay 314, application 102 replaces the storage location overlay 314 with a storage location overlay 322 having a different one or more combinations of a symbol, a color, and/or a shape relative to the storage location overlay 314 as shown in FIG. 3B. For example, a visual look of the storage location overlay 314 is different from a visual look of the storage location overlay 322 by at least one of: color, shape, and/or associated symbol.

Alternatively, or in addition, in FIG. 3B, application 102 may display a second feature 320 prompting the user to add and/or associate a case to the storage area 308 and/or the storage location. For example, a second image 304 may show cases that are already added and/or associated with the storage area 308 and/or the storage location in the database. In some embodiments, those cases that are already added and/or associated with the storage area 308 and/or the storage location in the database are depicted with an indicator case overlay 324. Alternatively, or in addition, those cases that have not been added and/or associated with the storage area 308 and/or the storage location in the database are depicted with an indicator case overlay 326. For example, a visual look of the indicator case overlay 324 is different from a visual look of the indicator case overlay 326 by at least one of: color, shape, and/or associated symbol. In an illustrative non-limiting example, the user may select case 310 (e.g., by tapping) to be added to and/or associated with the storage area 308 and/or the storage location in the database. In response to the selection of case 310, the indicator case overlay 326 is replaced by the indicator case overlay 324 indicating that case 310 is now associated with the location label 316 in the database as shown in a third image 306 of FIG. 3C. In such embodiments, application 102 overlays an indicator case overlay over a machine detectable identifier of a corresponding case stored in a storage location.

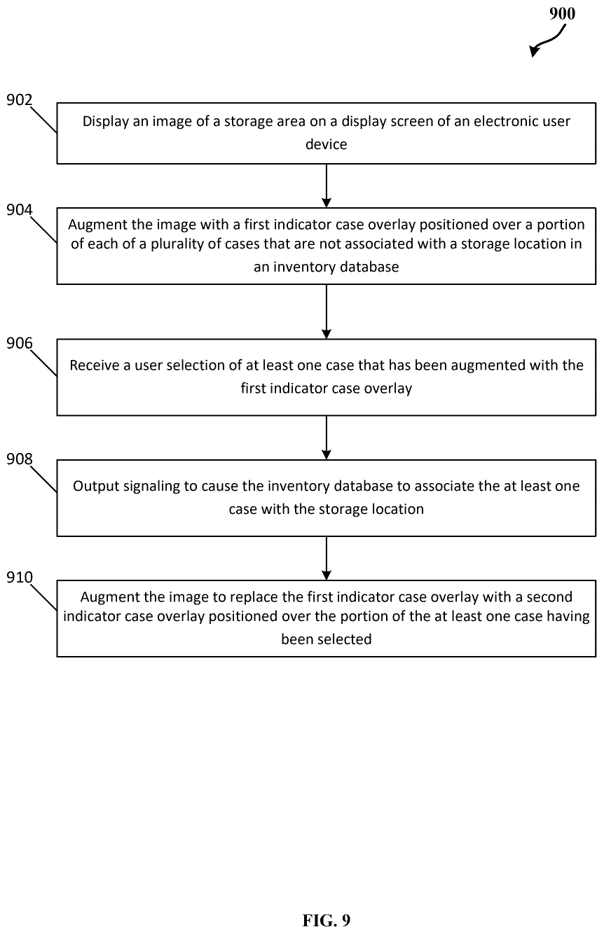

To further illustrate, FIGS. 3A-3C are additionally described with the steps shown in FIG. 9 depicting a flow chart of a method 900 for auditing retail inventory. In some embodiments, at step 902, application 102 displays the first image 302 of the storage area 308 and/or the storage location on a display screen 110 of an electronic user device 106 as shown in FIG. 3A. Alternatively, or in addition, at step 904, application 102 may augment the first image 302 with an indicator case overlay 326 positioned over a portion of each of the plurality of cases that are not associated with the storage area 308 and/or the storage location in an inventory database 118 as shown in FIG. 3B. Alternatively, or in addition, application 102 may augment the first image 302 with a storage location overlay 314 positioned over at least a portion of the location label 316 as shown in FIG. 3A. Alternatively, or in addition, at step 906, application 102 may receive a user selection of at least one case (e.g., case 310 in the second image 304) that has been augmented with the first indicator case overlay 326. Alternatively, or in addition, at step 908, application 102 may output signaling to cause the inventory database 118 to associate the at least one case (e.g., case 310) with the storage location 308 and/or the location label 316 in the inventory database 118. Alternatively, or in addition, at step 910, application 102 may augment the second image 304 to replace the indicator case overlay 326 with another indicator case overlay 324 positioned over the portion of the at least one case having been selected as shown in FIG. 3C. In some embodiments, the indicator case overlay 324 is positioned over the machine detectable identifier 312. In some embodiments, the indicator case overlay 324 indicates to the user that the at least one case (e.g., case 310) is associated with the storage location 308 and/or the location label 316 in the inventory database 118.

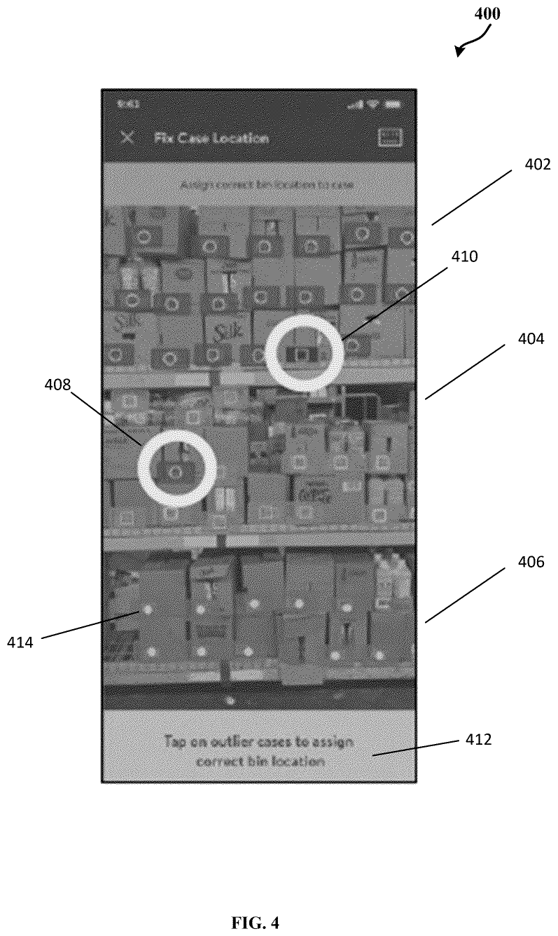

FIG. 4 shows an image 400 of a plurality of storage areas 400 shown on a display screen 110 during an audit of retail inventory in accordance with some embodiments. For example, image 400 depicts the first storage area 402, a second storage area 404, and a third storage area 406. In some embodiments, a user may select a storage area to audit by tapping on a portion of the display screen 110 where the storage area to be audited is depicted. Alternatively or in addition, in response to the selection of the storage area, the application may cause all adjacent cases to be associated with corresponding indicator case overlays with distinctive shapes, symbols, and/or colors based on whether the cases have been associated with a particular storage area shown in the image 400 in order for the user to quickly identify which cases are out of place and/or which cases have not been associated with a particular storage area. For example, application 102 may augment the image 400 with corresponding indicator case overlays positioned over a portion of each of the plurality of cases that are associated with corresponding storage locations in the inventory database 118 as shown in FIG. 4. For example, image 400 shows that the case associated with an indicator case overlay 410 is shown to be associated with the second storage area 404. In another example, the case associated with an indicator case overlay 408 is shown to be associated with the first storage area 402. In another example, the case associated with an indicator case overlay 414 is shown to be associated with the third storage area 406.

In an illustrative non-limiting example, a user may determine that the case associated with the indicator case overlay 410 was incorrectly associated with the second storage area 404 and that the case should have been associated with the first storage area 402. In some embodiments, application 102 may prompt a user to select and/or assign a correct storage location (e.g., bin) to a case via a feature 412 by tapping the corresponding indicator case overlay of an outlier case (e.g., the case associated with the indicator case overlay 410). In some embodiments, in response to the user making a selection of the case (e.g., tapping on the corresponding indicator case overlay), application 102 may receive the user selection of at least one case that has been augmented with an incorrect indicator case overlay (e.g., the case associated with the indicator case overlay 410).

Alternatively, or in addition, application 102 may output a signaling to cause the inventory database 118 to reassociate the at least one case that has been augmented with the incorrect indicator case overlay from the second storage area 404 to the first storage area 402. In some embodiments, a remote control circuit 120 communicatively coupled to the inventory database 118 may update the inventory database 118 to reassociate the at least one case that has been augmented with the incorrect indicator case overlay from the second storage area 404 to the first storage area 402 upon a receipt of the signaling from the application 102. In some embodiments, the remote control circuit 120 may transmit signaling to application 102 including information of the reassociation of the at least one case with the first storage area 402. In some embodiments, in response to the reassociation, application 102 may update the indicator case overlay shown with the correct indicator case overlay associated with the first storage area 402. In some embodiments, the remote control circuit 108 is implemented with a remote server communicationally coupled to the electronic user device 106 via a computer network. It is noted that in some embodiments, the inventory database 118 can be stored and maintained remotely from the electronic user device 106, e.g., in a cloud server, or server located in the store. In some embodiments, at least a portion of the inventory database 118 may be implemented or stored in memory 104 of the electronic user device 106.

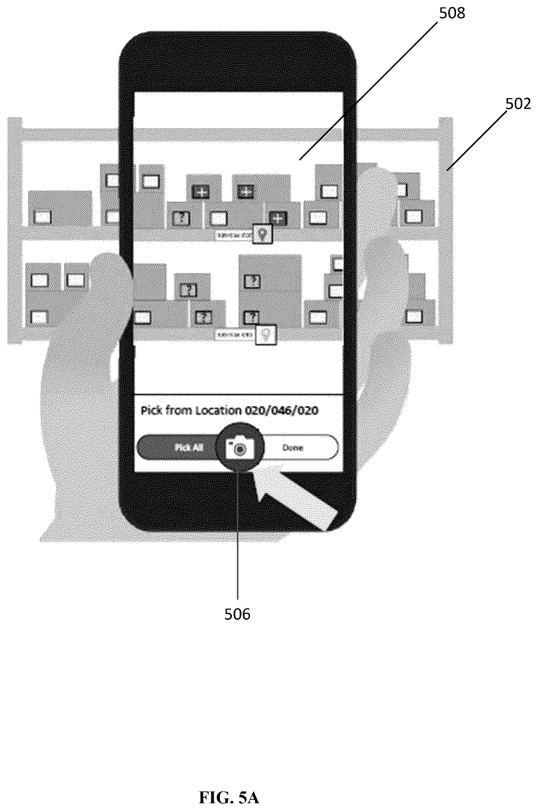

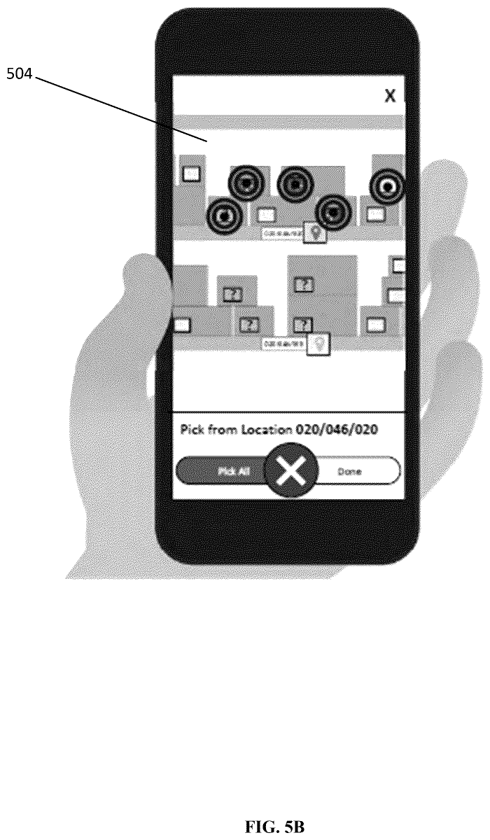

FIGS. 5A-5B show images during an audit of retail inventory in accordance with some embodiments. In some embodiments, to start an audit of retail inventory, a user (e.g., a retail associate and/or a contractor) may activate application 102 (e.g., by tapping on an icon associated with application 102 and/or initiating operation of an electronic user device 106, to name a few) to display a user interface on the display screen 110 of the electronic user device 106. Application 102 can be stored locally in memory 104 of the electronic user device 106 and/or stored in a network cloud storage accessible via a communication network 114. In some embodiments, the electronic user device 106 may include a smartphone, a laptop, and/or any portable electronic devices capable of capturing one or more images (such as having a camera). In some embodiments, the audit of retail inventory may be initiated by a robotic machine capable of automatically maneuvering across aisles inside a facility and capable of capturing one or more images of storage locations and/or cases stored in the storage locations.

In some embodiments, a user may hover or hold the electronic user device 106 in front of a storage location 502 such that a live image 508 of the storage area 502 is captured by an image capture device 116 as shown in FIG. 5A. The live image can change in response to the view of the image capture device 116 as a user holds the electronic user device 106. In some embodiments, application 102 may start determining and/or recognizing cases in the live image 508 shown in the display screen 110. In some embodiments, application 102 may provide a feature 506 on the user interface 122 that allows a user to cause the image capture device 116 to capture a static version of the live image 508. For example, when the user selects feature 506, the image capture device 116 captures a static image 504 of the live image 508 as shown in FIG. 5B. Once captured, static image 504 is independent of a view of the image capture device 116. Thus, once captured, the user may hold the electronic user device 106 in any comfortable position to viewing image overlays and make user selections without having to point the image capture device 116 at the storage location.

In some embodiments, application 102 may overlay a storage location overlay over a location label of the storage area 502 depicted on the static image 504. The location label may indicate identifiable information of the storage area 502. Alternatively, or in addition, application 102 may overlay an indicator case overlay over a machine detectable identifier of a corresponding case of a plurality of cases. To illustrate, in FIGS. 3A-3C, the storage location overlay 314 and/or the storage location overlay 322 is shown overlaid on the location label 316 of the storage area 308. In another illustrative non-limiting example, the indicator case overlay 326 or the indicator case overlay 324 is overlaid over the machine detectable identifier 312 of case 310 in FIGS. 3A-3C.

In some embodiments, after the static image 504 of the live image 508 is captured, application 102 may start augmenting the static image 504 with corresponding storage location overlays over location labels depicted on the static image 504. Alternatively or in addition, application 102 may receive a user selection of a storage location overlay to cause the application 102 to augment the static image 504 with a first indicator case overlay positioned over a portion of each of the plurality of cases that are not associated with the selected storage location overlay in the inventory database. The first indicator case overlay is indicative to the user that the corresponding cases have not been associated with the selected storage location overlay. Alternatively, or in addition, a second indicator case overlay may be positioned by the application 102 over a portion of each of the remaining plurality of cases that are currently associated with the selected storage location overlay. The second indicator case overlay being visually different from the first indicator case overlay by at least one of: color, shape, and/or associated symbol. Alternatively, or in addition, the selected storage location overlay may be visually different from unselected storage location overlay by at least one of: color, shape, and/or associated symbol.

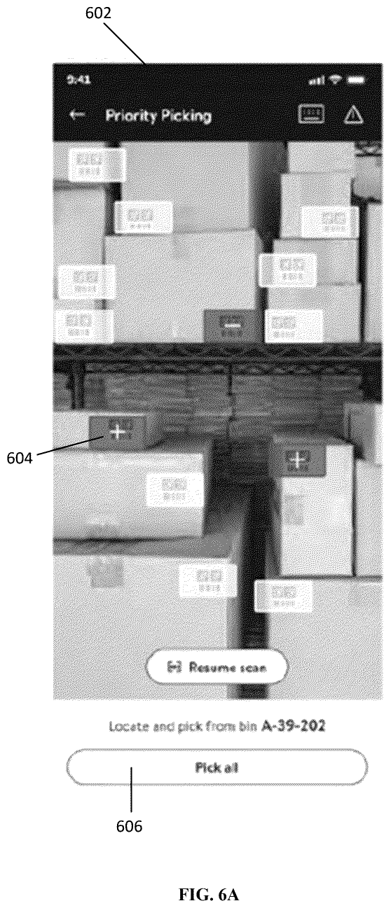

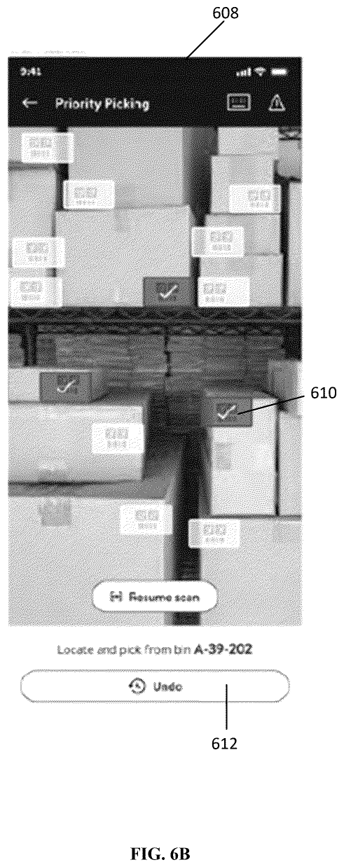

FIGS. 6A-6B show images during an audit of retail inventory in accordance with some embodiments. In some embodiments, application 102 may display a selection feature 606 in the user interface that enables a user to simultaneously select all cases that have been augmented with an indicator case overlay 604 as shown in the first image 602 of FIG. 6A. Alternatively, or in addition, after the selection feature 606 has been selected, application 102 may simultaneously cause all cases that have been augmented with the indicator case overlay 604 to be reassociated in the inventory database 118. Alternatively, or in addition, after the reassociation in the inventory database 118, application 102 may replace the indicator case overlay 604 with an indicator case overlay 610 indicating that the cases are now associated with the selected storage location and/or depicted storage location as shown in a second image 608 of FIG. 6B. In some embodiments, application 102 may display another selection feature 612 in the user interface 122 that enables a user to undo the reassociation.

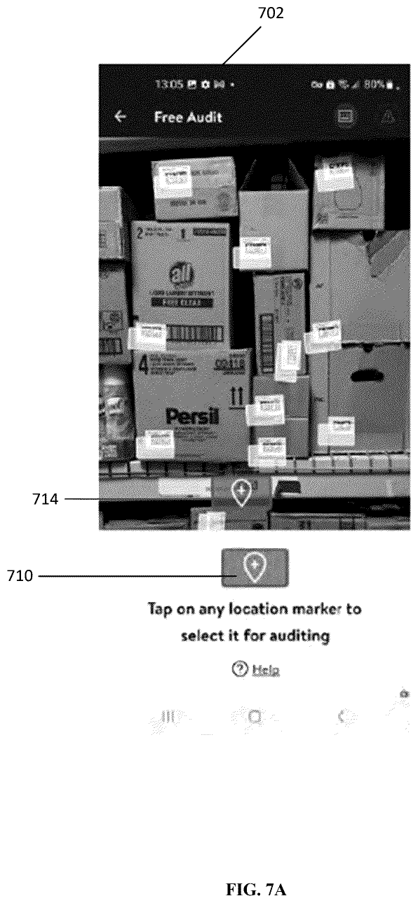

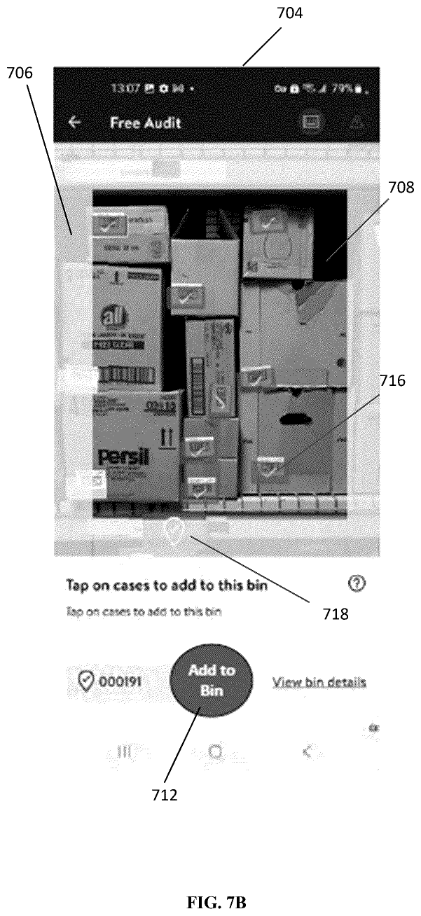

FIGS. 7A-7B show images during an audit of retail inventory in accordance with some embodiments. In some embodiments, application 102 may provide a feature 710 in the user interface 122 prompting a user to select any storage location overlay depicted on a first image 702 for auditing as shown in FIG. 7A. For example, the user may select a storage location overlay 714. Application 102 may replace the storage location overlay 714 with the selected storage location overlay 718 indicating that the corresponding storage location has been selected as shown in FIG. 7B. In some embodiments, in response to receiving the selection of the storage location overlay 714, application 102 may augment the first image 702 with a window feature having a first portion 708 and a second portion 706 as shown in a second image 704 of FIG. 7B. In some embodiments, cases that have been augmented with an indicator case overlay 716 and enclosed within the first portion 708 of the second image 704 are available to be selected by the user to be added to the selected storage location overlay 718. Alternatively, application 102 may provide feature 712 in the user interface 122 prompting the user to add cases with the indicator case overlay 716 to the selected storage location overlay 718 in the inventory database as shown in FIG. 7B. In some embodiments, application 102 may automatically overlay the indicator case overlay 716 over a portion of all cases enclosed within the first portion 708 of the window feature. In some embodiments, application 102 may only allow cases enclosed within the first portion 708 to be selected by the user, and once selected, augmented with the indicator case overlay 716.

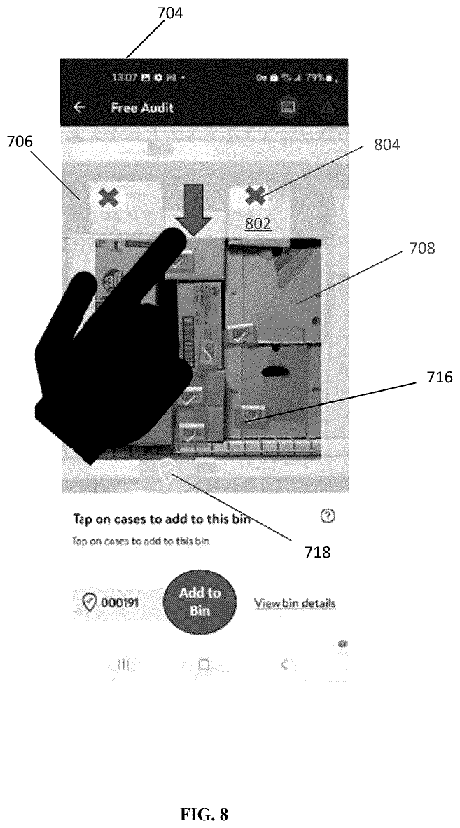

FIG. 8 shows an image during an audit of retail inventory in accordance with some embodiments. In some embodiments, the first portion 708 may be resizable to dynamically change a range of cases enclosed within the first portion 708 of the second image 704 of FIG. 8. Alternatively or in addition, those cases (e.g., case 802) that are now outside the first portion 708 are augmented by the application 102 with an indicator case overlay 804 indicating that the cases are no longer selectable by the user to be added to the selected storage location associated with the selected storage location overlay 718.

The embodiments described herein allows associates of a facility (e.g., a retail store and/or distribution center, to name a few) to quickly obtain items and/or products from the backroom and/or identify and resolve backroom inaccuracies to maximize the chances that items/products are in the correct spot/location as reflected in the inventory database 118. For example, as time goes on, items/products are moved from one storage area/storage location to another storage area/storage location one or more times and these items/products are not always replaced in the storage area/storage location they were moved from. Consequently, over time, some of these items/products are not where the remote control circuit 120 via its access to the inventory database 118 determines the items/products to be and/or as reflected in the inventory database 118. Accordingly, in some embodiments allow for intuitive visualization of products/items/cases that are unassigned or incorrectly assigned to storage locations/areas in the inventory database and mechanisms to assign/reassign to the products/items/cases to the storage locations/areas at which they are currently located.

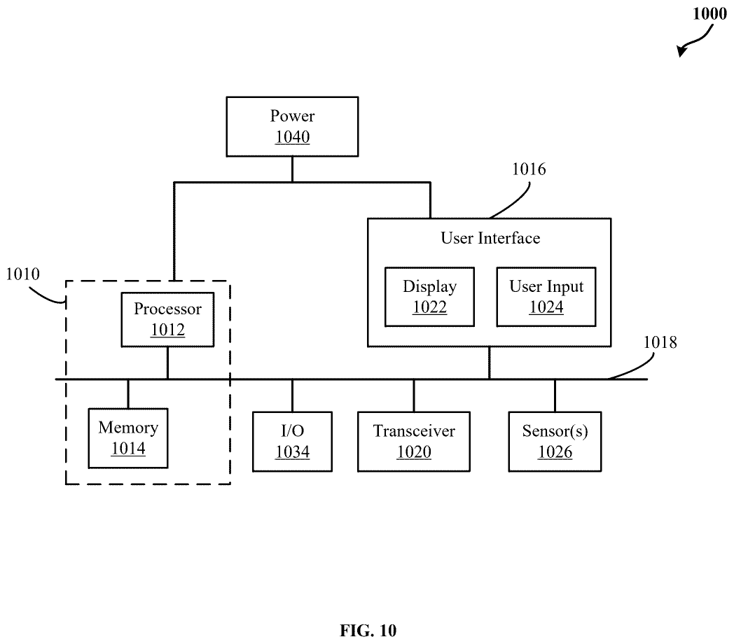

Further, the circuits, circuitry, systems, devices, processes, methods, techniques, functionality, services, servers, sources and the like described herein may be utilized, implemented and/or run on many different types of devices and/or systems. FIG. 10 illustrates a system 500 that may be used for implementing any of the components, circuits, circuitry, systems, functionality, apparatuses, processes, or devices of the system 100 of FIG. 1 and the method 900 of FIG. 9, and/or other above or below mentioned systems or devices, or parts of such circuits, circuitry, functionality, systems, apparatuses, processes, or devices. For example, the system 1000 may be used to implement some or all of the system for auditing retail inventory, the electronic user device 106, the memory 104, the application 102, the display screen 110, the control circuit 108, the image capture device 116, the inventory database 118, the remote control circuit 120, and/or other such components, circuitry, functionality and/or devices. However, the use of the system 1000 or any portion thereof is certainly not required.

By way of example, the system 1000 may comprise a processor module (or a control circuit) 1012, memory 1014, and one or more communication links, paths, buses or the like 1018. Some embodiments may include one or more user interfaces 1016, and/or one or more internal and/or external power sources or supplies 1040. The control circuit 1012 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1012 can be part of control circuitry and/or a control system 1010, which may be implemented through one or more processors with access to one or more memory 1014 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, system 1000 may be used to implement one or more of the above or below, or parts of, components, circuits, systems, processes and the like. For example, system 1000 may implement the system for auditing retail inventory with the control circuit 108 and/or the remote control circuit 120 being the control circuit 1012.

The user interface 1016 can allow a user to interact with the system 1000 and receive information through the system. In some instances, the user interface 1016 includes a display 1022 and/or one or more user inputs 1024, such as buttons, touch screen, track ball, keyboard, mouse, etc., which can be part of or wired or wirelessly coupled with the system 1000. Typically, the system 1000 further includes one or more communication interfaces, ports, transceivers 1020 and the like allowing the system 1000 to communicate over a communication bus, a distributed computer and/or communication network (e.g., a local area network (LAN), the Internet, wide area network (WAN), etc.), communication link 1018, other networks or communication channels with other devices and/or other such communications or combination of two or more of such communication methods. Further the transceiver 1020 can be configured for wired, wireless, optical, fiber optical cable, satellite, or other such communication configurations or combinations of two or more of such communications. Some embodiments include one or more input/output (I/O) interface 1034 that allow one or more devices to couple with the system 1000. The I/O interface can be substantially any relevant port or combinations of ports, such as but not limited to USB, Ethernet, or other such ports. The I/O interface 1034 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1026 to provide information to the system and/or sensor information that is communicated to another component, such as the electronic user device 106, the memory 104, the application 102, the display screen 110, the control circuit 108, the image capture device 116, the inventory database 118, the remote control circuit 120, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

System 1000 comprises an example of a control and/or processor-based system with the control circuit 1012. Again, the control circuit 1012 can be implemented through one or more processors, controllers, central processing units, logic, software and the like. Further, in some implementations the control circuit 1012 may provide multiprocessor functionality.

The memory 1014, which can be accessed by the control circuit 1012, typically includes one or more processor readable and/or computer readable media accessed by at least the control circuit 1012, and can include volatile and/or nonvolatile media, such as RAM, ROM, EEPROM, flash memory and/or other memory technology. Further, memory 1014 is shown as internal to the control system 1010; however, the memory 1014 can be internal, external or a combination of internal and external memory. Similarly, some or all of the memory 1014 can be internal, external or a combination of internal and external memory of the control circuit 1012. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. Memory 1014 can store code, software, executables, scripts, data, content, lists, programming, programs, log or history data, user information, customer information, product information, and the like. While FIG. 10 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for auditing retail inventory, the system comprising:
an application configured to be stored in a memory of an electronic user device and be executed by a control circuit of the electronic user device, wherein when executed, the application provides a user interface on the electronic user device, the application configured to:
display an image of a storage area on a display screen of the electronic user device, wherein the image includes a storage location and a plurality of cases positioned at the storage location, wherein the plurality of cases have machine detectable identifiers;
augment the image with a first indicator case overlay positioned over a portion of each of the plurality of cases that are not associated with the storage location in an inventory database;
receive a user selection of at least one case that has been augmented with the first indicator case overlay;
output signaling to cause the inventory database to associate the at least one case with the storage location; and
augment the image to replace the first indicator case overlay with a second indicator case overlay positioned over the portion of the at least one case having been selected, the second indicator case overlay indicating to a user that the at least one case is associated with the storage location in the inventory database.

2. The system of claim 1, wherein the application is further configured to augment the image with the second indicator case overlay positioned over a portion of each of the plurality of cases that are associated with the storage location in the inventory database.

3. The system of claim 1, wherein a visual look of the first indicator case overlay is different from a visual look of the second indicator case overlay by at least one of: color, shape, and associated symbol.

4. The system of claim 3, wherein the image depicts a second storage area, and wherein the application is further configured to:
receive a second user selection of at least one case that has been augmented with the second indicator case overlay;
output a second signaling to cause the inventory database to reassociate the at least one case that has been augmented with the second indicator case overlay from the storage area to the second storage area.

5. The system of claim 1, wherein the application is further configured to augment the image with a storage location overlay positioned over a portion of the storage location.

6. The system of claim 5, wherein the application is further configured to:
overlay the storage location overlay over a location label of the storage area depicted on the image, the location label indicating an identifiable information of the storage area; and
overlay the first indicator case overlay over a machine detectable identifier of a corresponding case of the plurality of cases.

7. The system of claim 5, wherein the application is further configured to receive a user selection of the storage location overlay to cause the application to augment the image with the first indicator case overlay positioned over the portion of each of the plurality of cases that are not associated with the storage location in the inventory database.

8. The system of claim 1, wherein a machine detectable identifier comprises a machine-readable code comprising Universal Product Code (UPC).

9. The system of claim 1, wherein the storage area comprises one of a shelf, a rack, and a pallet.

10. The system of claim 1, wherein the image comprises one of:
a static image of the storage area captured by an image capture device, and once captured, the static image is independent of a view of the image capture device; and
a live image of the storage area captured by the image capture device, the live image changing in response to the view of the image capture device.

11. The system of claim 1, wherein the application is further configured to display a selection feature that enables a user to simultaneously select all cases that have been augmented with the first indicator case overlay.

12. The system of claim 1, wherein the application is further configured to display the image having a first portion and a second portion, wherein cases that have been augmented with the first indicator case overlay and enclosed within the first portion of the image are available to be selected by a user.

13. The system of claim 12, wherein the first portion of the image is resizable to dynamically change a range of cases enclosed within the first portion of the image and augmented with the first indicator case overlay.

14. The system of claim 1, further comprising a remote control circuit communicatively coupled to the inventory database, the remote control circuit configured to update the inventory database to associate the at least one case with the storage location upon a receipt of the signaling from the application.

15. A method for auditing retail inventory, the method comprising:
displaying, by an application stored in a memory of an electronic user device and when executed by a control circuit of the electronic user device, an image of a storage area on a display screen of the electronic user device, wherein the image includes a storage location and a plurality of cases positioned at the storage location, wherein the plurality of cases have machine detectable identifiers;
augmenting, by the application, the image with a first indicator case overlay positioned over a portion of each of the plurality of cases that are not associated with the storage location in an inventory database;
receiving, by the application, a user selection of at least one case that has been augmented with the first indicator case overlay;
outputting, by the application, signaling to cause the inventory database to associate the at least one case with the storage location; and
augmenting, by the application, the image to replace the first indicator case overlay with a second indicator case overlay positioned over the portion of the at least one case having been selected, the second indicator case overlay indicating to a user that the at least one case is associated with the storage location in the inventory database.

16. The method of claim 15, wherein the image depicts a second storage area, and further comprising:
receiving, by the application, a second user selection of at least one case that has been augmented with the second indicator case overlay;
outputting, by application, a second signaling to cause the inventory database to reassociate the at least one case that has been augmented with the second indicator case overlay from the storage area to the second storage area.

17. The method of claim 15, further comprising augmenting, by the application, the image with a storage location overlay positioned over a portion of the storage location.

18. The method of claim 17, further comprising receiving, by the application, a user selection of the storage location overlay to cause the application to augment the image with the first indicator case overlay positioned over the portion of each of the plurality of cases that are not associated with the storage location in the inventory database.

19. The method of claim 15, wherein the image comprises one of:
a static image of the storage area captured by an image capture device, and once captured, the static image is independent of a view of the image capture device; and
a live image of the storage area captured by the image capture device, the live image changing in response to the view of the image capture device.

20. The method of claim 15, further comprising displaying, by the application, a selection feature that enables a user to simultaneously select all cases that have been augmented with the first indicator case overlay.

21. The method of claim 15, further comprising displaying, by the application, the image having a first portion and a second portion, wherein cases that have been augmented with the first indicator case overlay and enclosed within the first portion of the image are available to be simultaneously selected by a user.

22. The method of claim 21, further comprising resizing the first portion of the image to dynamically change a range of cases enclosed within the first portion of the image and augmented with the first indicator case overlay.
